(19) United States
(12) Patent Application Publication
(10) Pub. No.: US 2012/0127743 A1
(43) Pub. Date: May 24, 2012

(54) LIGHTING DEVICE AND METHOD FOR ASSEMBLING A LIGHTING DEVICE

(76) Inventors: Guenter Hoetzl, Regensburg (DE); Thomas Preuschl, Sinzing (DE); Peter Sachsenweger, Zeitlarn (DE)

(21) Appl. No.: 13/388,251

(22) PCT Filed: Jul. 31, 2010
(86) PCT No.: PCT/EP10/60059

§ 371 Date: Jan. 31, 2012

(51) Int. Cl. F21V 21/08; B23P 11/02; F21V 21/00

(52) U.S. Cl. 362/396; 362/382; 29/446

(57) ABSTRACT

A lighting device (1; 50; 60; 70; 100; 100b), comprising: a body (4), having an outer contact surface (24); and a light source carrier (6), pressed onto the contact surface by at least one pressing element (43; 51; 61; 71; 101; 108; 220), wherein the pressing element is latched on the lighting device.

The invention relates to lighting devices, in particular LED retrofit lamps. The invention also relates to a method for producing one of the lighting devices.

LED retrofit lamps and their light sources are typically operated using a safety extra low voltage (SELV). For this purpose, the LED retrofit lamp comprises a driver for operating the LED(s) which includes a voltage regulator for converting a mains voltage, for example of 230 V, to a voltage of approximately 10 V to 25 V, typically a transformer. The efficiency of a SELV driver is typically between 70% and 80%. In SELV devices, insulation distances of at least 5 mm between a primary side and a secondary side in relation to the voltage regulator have to be maintained for the protection of a consumer so as to prevent the user from receiving an electric shock caused by leakage currents. In particular, surge pulses of up to 4 KV originating from a mains supply should be kept away from the secondary side so that there is also no risk to the user if he touches live, accessible parts such as the heat sink during the occurrence of the surge. The LED lamp must also meet specific flame retardance ratings, which was previously only achieved by materials having a high flame retardance rating or by use of metal joining elements.

For example, LED retrofit lamps may be designed so that the LED(s) is/are mounted on a carrier which is screwed to the heat sink and is electrically insulated therefrom. A necessary length of the leakage path or insulation between potential-carrying or electrically conductive surface areas (contact fields, line tracks, etc., for example on copper and/or conductive paste with silver for example) and the heat sink is achieved by firstly observing a distance of at least 5 mm between the potential-carrying surface areas and an edge of the carrier, and by secondly observing an electrically insulating area of at least 5 mm around the screwing points. However, such a design has a large surface area requirement.

The object of the present invention is to provide a cost-effective and compact lighting device, in particular an LED retrofit lamp, which can be assembled in a particularly simple manner.

This object is achieved by means of a plurality of lighting devices and a method according to the respective independent claim. Preferred embodiments can be derived in particular from the dependent claims.

The object is achieved by means of a lighting device which comprises at least
a body having an outer contact surface and
a light source carrier which is pressed by means of at least one pressing element onto the contact surface,
wherein the pressing element is latched on the lighting device.

As a result of the latching, a pressing element which is particularly simple in terms of design and handling is provided which can also be formed using particularly lightweight elements and a multiplicity of materials. In addition, a latching operation is well-suited for use in an automated process. In contrast to a design with screws, there is no reduction in air gaps and leakage paths owing to the design without screws.

Generally, the type of latching is not restricted and may, for example, be formed as a snap-in connection (annular snap-in, ball snap-in, bending snap-in and/or torsional snap-in connection, etc.) or as a ratchet-like latching. The latching may be carried out using any suitable elements, for example by means of latching hooks, latching protrusions, toothings, etc.

In particular, the body may be a heat sink. The heat sink may advantageously consist of an effective heat-conducting material with λ>10 W/(m·K), more preferably λ>100 W/(m·K), in particular of a metal such as aluminium, copper or an alloy thereof. The heat sink may also consist completely or in part of a plastics material, however; an effective heat-conducting and electrically insulating plastics material is particularly advantageous for electrical insulation and extension of the leakage paths, however the use of an effective heat-conducting and electrically conductive plastics material is also possible. The heat sink may be substantially symmetrical, in particular substantially rotationally symmetrical, for example about a longitudinal axis. The heat sink may comprise heat dissipation elements, for example cooling ribs or cooling pins.

The light source carrier may comprise one or more light sources. The type of light sources is not limited for the time being. However, it is preferable for operation with low power loss and particularly compact construction if the light source is a semiconductor source, for example a laser diode or a light-emitting diode (LED).

The semiconductor light source may comprise one or more emitters. The semiconductor emitter(s) may be applied to the carrier, on which further electronic components such as resistors, capacitors, logical units, etc. can be mounted. For example, the semiconductor emitters may be applied to the carrier by means of conventional soldering methods. However, the semiconductor emitters may also be connected to a substrate (submount) by chip-level connection types, such as bonding (wire bonding, flip-chip bonding), etc., for example by fitting a substrate made of AlN with LED chips. One or more submounts may also be mounted on a printed circuit board. With the presence of a plurality of semiconductor emitters, these may irradiate in the same colour, for example white, which allows simple scalability of brightness. However, the semiconductor emitters may also have a different beam colour, at least in part, for example red (R), green (G), blue (B), amber (A), mint (M) and/or white (W), etc. A beam colour of the light source can thus optionally be varied, and any colour point can be set. In particular it is preferable if semiconductor emitters of different beam colour can produce a white mixed light. Organic LEDs (OLEDs) can also generally be used, either instead of or in addition to inorganic LEDs, for example based on InGaN or AlInGaP.

The carrier may be designed as a printed circuit board or another substrate, for example as a compact ceramic body. The carrier may have one or more wiring layers.

It may be advantageous, for the uniform distribution of a plurality of light sources, in particular LEDs, with a simultaneously simple design of the leakage paths whilst observing predefined insulation paths, if the carrier is arranged peripherally and concentrically or coaxially with an upwardly protruding cable feed element, for example a cable duct. A low lateral extension of the carrier relative to a longitudinal axis of the heat sink is thus also achieved. It may be advantageous, in order to observe predefined insulation paths, if the light sources are arranged substantially uniformly in the peripheral direction.

The carrier may advantageously be attached to the heat sink by means of an electrically insulating interface layer. The electrically insulating interface layer may advantageously be adhesive on both sides for a reliable connection between the carrier and heat sink. For example, the interface layer may be a thermal interface material (TIM), such as a heat-conductive paste (for example silicone oil with additives of aluminium oxide, zinc oxide, boron nitride or silver powder), a film or a pad or a mat. Alternatively, a silicone layer or the like may be used, for example. The interface layer may also afford the advantages of a high dielectric strength and an extension of the leakage path.

The carrier may generally comprise at least one electrically insulating insulation layer. An insulation layer may particularly advantageously consist of a material which is a good thermal conductor and a poor electrical conductor, at least in the direction of thickness. An insulation layer made of ceramics, such as Al₂O₃, AlN, EN or SiC is particularly advantageous. The insulation layer may be formed as a multi-layered ceramics carrier, for example using LTCC technology. For example, layers comprising different materials may also be used, for example those comprising different ceramics. For example, these may be formed so as to be highly dielectric and poorly dielectric in an alternating manner. The at least one insulation layer may also consist of a typical base material for a printed circuit board, such as FR4, which is less advantageous from a thermal point of view but very cost effective. The carrier may advantageously have a dielectric strength of at least 4 KV so that surge pulses, at least of this magnitude, do not penetrate the carrier.

To achieve a particularly advantageous compromise between maximisation of the insulation path and minimisation of the thermal path between light source(s) and heat sink, a thickness of the carrier may advantageously lie in a range between 0.16 mm and 1 mm.

In one embodiment the pressing element is latched on the lighting device by means of at least one latching hook. Latching hooks can be produced in a simple manner and typically engage in a latching counter-element, for example a latching seat, provided on the lighting device.

In a specific embodiment the pressing element is annular. The annular design is particularly advantageous for use with a plurality of latching hooks, since the plurality of latching hooks can be spaced over the ring and a particularly stable and spatially distributed attachment to the lighting device is thus enabled. A uniform pressing force which is exerted by the pressing element onto the light source carrier is consequently provided.

In a further specific embodiment the lighting device comprises at least one latching seat for receiving at least one latching hook, for example a corresponding groove, wherein at a contact face with the latching hook the latching seat is bevelled in a flared manner toward the opening of the latching seat. The latching hook can thus slide into the latching seat within a limited scope and experiences a difference in height. A tolerance compensation with regard to the carrier can thus be achieved in turn, whereby the pressing force onto the carrier and the pressing force of the carrier onto its base, in particular the body, can be kept within a predetermined range. This prevents damage to the pressing element, the carrier or any other elements located in the path of force, such as any interface layers. In another specific embodiment an angle of inclination, which is also a releasing and joining angle, of the contact face is between 5° and 15°. It has been found that a rigid fit of the pressing element with a simultaneous high level of protection of the components located in the force flow against mechanical damage caused by the pressing operation is achieved in this angular range.

In another embodiment the body comprises a recess and a through-opening from the recess to the contact surface. Electrical connections, etc. can thus be guided directly from the recess to the printed circuit board. A cable feed element, for example a cable duct, can be inserted into the through-opening. The cable feed element may protrude from the contact surface and be screwed there to the pressing element. The cable feed element comprises a latching means for this, at least on its outer face protruding beyond the contact surface.

In another embodiment the pressing element is latched on the lighting device by means of at least one toothed latching ring. For example, the latching ring may be fitted onto the cable feed element. Latching may be achieved, for example, by means of a toothing of the latching ring, the cable feed element or of both elements. For this purpose, in one variant the cable feed element may comprise a toothing on its outer face or a locking element for engagement in a toothing, whereas the latching ring has a corresponding structure (toothing, catches, etc.) on its inner face. The latching ring may then be fitted easily over the cable feed element until the pressing element is placed on the carrier. Such a latching may be designed, for example, similarly to a latching of a cable tie. In particular in the case of a toothing, a pressing force on the carrier can be adjusted, at least roughly, via a corresponding relative positioning of the pressing element and the cable feed element.

The recess may in particular be formed and/or provided as a driver cavity for receiving a driver for the light sources. The recess advantageously has an insertion opening for the introduction of the driver, for example a driver printed circuit board. The insertion opening of the recess may advantageously be located on a rear face of the heat sink. The insertion opening and the cable feed element are advantageously located on opposite sides of the recess. For example, the recess may be cylindrical. The recess may advantageously be electrically insulated from the heat sink so as to avoid direct leakage paths, for example by means of an electrically insulating coating (also called a driver cavity housing or DCG), for example in the form of a plastics material tube inserted into the recess through the insertion opening. The coating may comprise one or more attachment elements for attachment of the driver.

The cable feed element is used to feed or pass through at least one electrical line between the driver located in the recess and the at least one semiconductor source and the carrier fitted thereto. The cable feed element and the coating may be formed in one piece as a single element. The cable feed element is then also pushed through a through-opening in the heat sink simultaneously with the insertion of the coating into the recess.

The at least one electrical line, which may be formed for example as a wire, a cable or a connector of any type, can be contacted by means of any suitable method, for example by means of soldering, resistance welding, laser welding, etc.

The driver may be a general control circuit for controlling the at least one semiconductor source. The driver is preferably designed as a non-SELV driver, in particular as a non-SELV driver having no transformer. A non-SELV driver has a greater efficiency of typically more than 90% compared to a SELV driver and can also be produced in a more cost effective manner. No safety spacings are required in the driver between the primary side and the secondary side, as is a prerequisite in a SELV driver with use of a transformer. Instead, a separation between the primary side and secondary side takes place primarily between the carrier and heat sink. With a non-SELV driver having no transformer the transformer may advantageously be replaced by a coil or a buck configuration/step-down converter.

The pressing element may be provided as a separately produced element which can be fitted on the lighting device.

In an alternative or additional embodiment the pressing element corresponds to the carrier. In other words, the pressing element is integrated in the carrier or the carrier includes the function of the pressing element. The carrier itself is thus attachable to the body by means of the rotary motion and thus itself presses against the contact surface. For this purpose, the light source carrier, for example the printed circuit board, as such may have a screw thread. Such a light source carrier can be applied to the embodiments already described above.

In a further embodiment the pressing element, which for example is provided in the form of a latching pin, is latched into the through-opening and is latched directly to the through-opening, that is to say the body, or to an insert located in the through-opening, for example a plastics material ring or a plastics material sleeve. The through-opening may consequently be formed as a latching bore, and the pressing element may be formed in a bolt-like manner with a laterally protruding head and possibly provided with an elongate bore. The pressing element may be pressed and latched into the through-opening from the outside and may thus press the carrier against the contact surface as a result of the latching. For example, cables, wires, etc. can be guided from the recess to the light source carrier through the cable duct formed as an elongate bore in the pressing element. Alternatively, the through-opening may be provided with an insert which has a latching bore for latching of the pressing element.

In an additional embodiment the carrier comprises a carrier opening arranged substantially concentrically with the through-opening. The cable feed element protruding from the through-opening or the pressing element screwed into the through-opening or insert therein can thus be used as a centring aid.

In yet another embodiment the pressing element is formed in the manner of a spring washer and is inserted, under, via at least a peripheral edge region into at least one latching seat in the lighting device. In this embodiment there is no need for any toothings or the like to be provided, which simplifies production. However, it is alternatively also possible to additionally equip the pressing element with a ratchet-like structure, for example a toothing. A pressing force on the carrier can thus be increased further.

To avoid a shortening of leakage paths or air gaps, it is advantageous if at least one surface of the pressing element consists of an electrically non-conductive material. The non-conductive material may be a plastics material for example. In a variant, the pressing element is produced completely from plastics material. Simple and cost-effective production is thus enabled. In a further variant the pressing element comprises a metal core which is surrounded by a plastics material casing. Greater strength and a greater modulus of elasticity of the pressing element are thus obtained.

In principle it is also possible to use a plurality of latching/pressing elements, for example a central latching/pressing element and a lateral, external latching/pressing element.

However, the lighting device is not limited to the use of at least one latching, pressing element (“latching/pressing element”), and instead additional other types of pressing elements may be used, for example a twisting/pressing element which is attached to the lighting device by means of a rotary motion. Such a twisting/pressing element may be screwed to the lighting device or attached by means of a bayonet connection. In particular, a pressing force can be adjusted with a comparatively high level of precision using a twisting/pressing element.

In another embodiment at least one pressing element (for example a latching/pressing or twisting/pressing element) comprises a carrier for a covering, which is light-permeable in particular. In a specific embodiment the covering element comprises at least one recess for at least one light source or parts thereof. The covering may protect the carrier against mechanical or other loading, at least in part, and may also act as a screen. The covering may, or may not be light-permeable. A light-permeable covering may also cover the light sources, whereas a light-impermeable covering comprises at least one recess in a region of a light cone of the light source. The light source may then be guided, at least in part, through the recess. Leaving the light source open through the covering in this manner affords the advantage that the covering does not impair a beam path of the light source and also does not absorb any light. The light source may be equipped with at least one optically active element, for example a lens, for beam guidance.

Generally, the cable feed element may also be arranged excentrically, for example offset laterally from the longitudinal axis of the heat sink or the substrate. The cable feed element may also be arranged outside a lateral extension of the carrier. The at least one electrical line can then be guided to the carrier, laterally from the outside.

It may generally be preferred if a leakage path is at least 1 mm long, more preferably at least 6.5 mm long. The air gap is preferably at least 4 mm.

An at least local heat conductivity or heat spread of the carrier may advantageously lie between 20 (W/m·K) and 400 (W/m·K), for example approximately 400 (W/m·K) for a copper layer.

The semiconductor light source may advantageously be fed by means of a non-SELV voltage, however use with a safety extra low voltage (SELV) is also possible.

The driver may be a non-SELV driver having no transformer.

The lighting device may particularly advantageously be formed as a retrofit lamp, in particular an LED retrofit lamp, or as a module therefor.

The object is also achieved by means of a method for assembling a lighting device, wherein the method comprises at least the following steps:
resiliently bending the pressing element so that the lateral extension thereof is reduced;
positioning the peripheral edge region adjacent to the at least one latching seat; and
releasing the pressing element so that the peripheral edge region enters the at least one latching seat.

Owing to the release of the pressing element, it may be relieved of tension, at least in part, thus expands again laterally and may consequently lower onto the carrier, wherein the pressing element continues to be tensioned so that is exerts a pressing force on the carrier. Such a design is particularly simple in terms of construction and can be produced in a cost-effective manner.

The object is also solved by means of a lighting device which comprises at least:
a body, in particular a heat sink, having an outer contact surface,
a light source carrier, in particular an LED carrier, which is pressed onto the contact surface by means of at least one pressing element,
wherein the pressing element is a hot caulked plastics material rivet.

A tolerance-compensating, permanent pressing at the carrier can thus be achieved, wherein protection against vibration is achieved by the permanent connection. In addition, the hot caulking can be carried out in a simple manner.

The object is further solved by a lighting device which comprises at least:
a body, in particular a heat sink, having an outer contact surface,
a light source carrier, in particular an LED carrier, which is pressed onto the contact surface by means of at least one pressing element,
wherein the pressing element is a latchingly expandable expansion sleeve.

A tolerance-compensating, permanent pressing onto the carrier (by the expansion sleeve) can thus also be achieved, wherein protection against vibration is achieved by the permanent connection. In addition, an expansion of the expansion sleeve can be carried out in a particularly simple manner.

In a development, the latching is continued up to a threshold value, for example up to a predefined pressing force or latching force.

The invention will be described schematically in greater detail in the following figures on the basis of embodiments. Like or functionally like elements may be provided with like reference numerals for improved clarity.

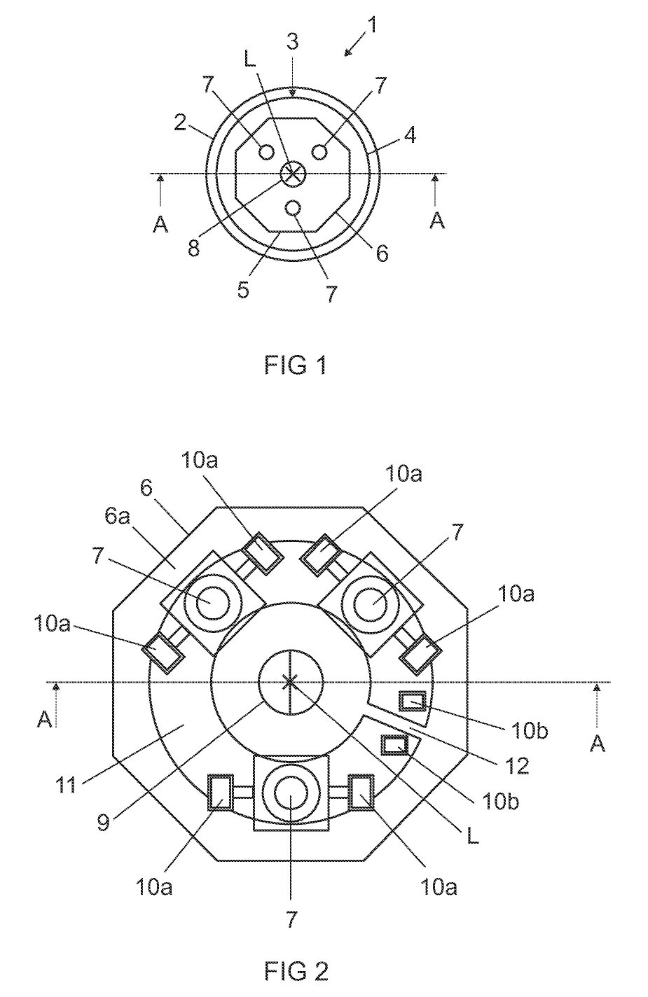

FIG. 1 shows a plan view of a first embodiment of an LED retrofit lamp having a fitted carrier;

FIG. 2 shows a detailed plan view of the carrier from FIG. 1;

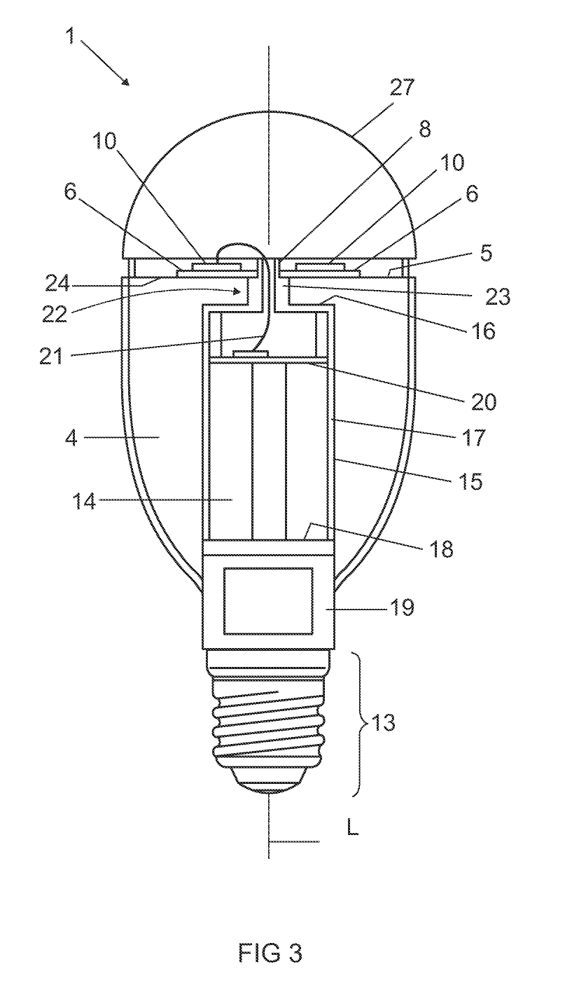

FIG. 3 shows a lateral sectional view along the sectional line A-A from FIG. 1 of the first embodiment of the LED retrofit lamp;

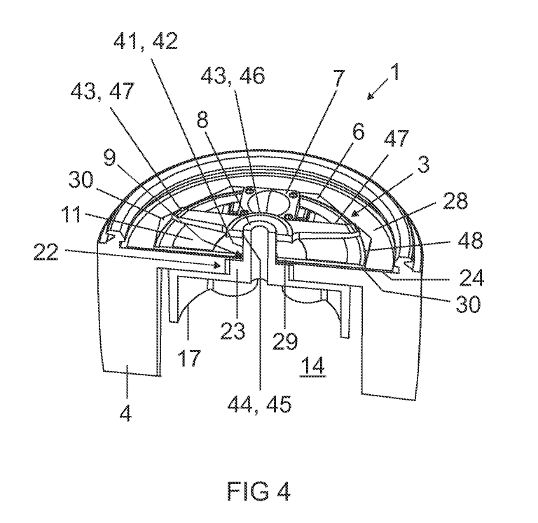

FIG. 4 shows an oblique view of a detailed portion from the sectional view of the first embodiment of the LED retrofit lamp;

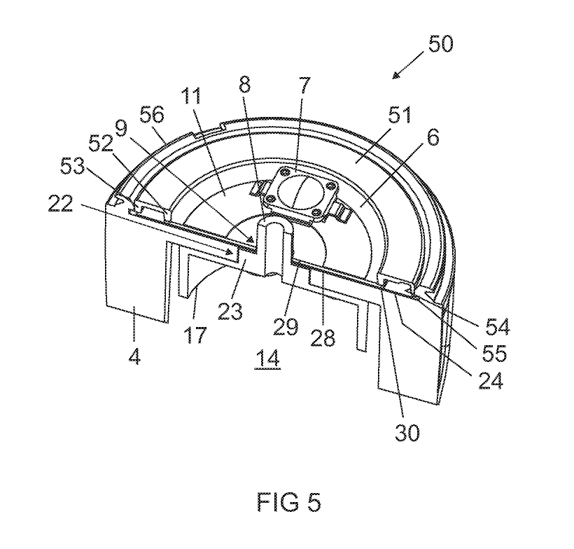

FIG. 5 shows a detail of a second embodiment of an LED retrofit lamp in a view similar to FIG. 4;

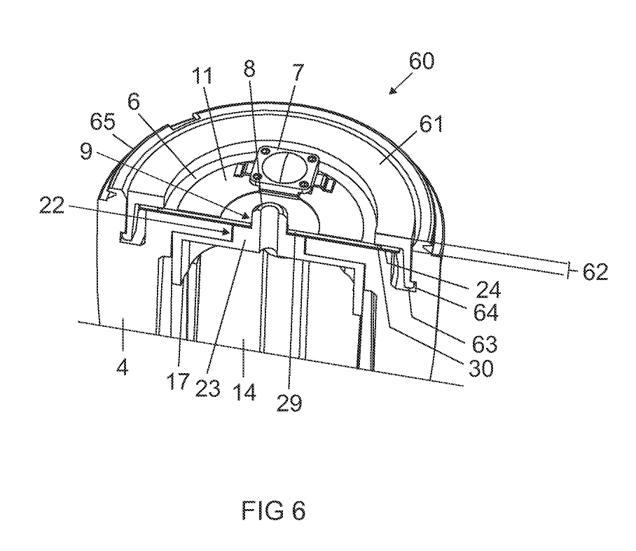

FIG. 6 shows a detail of a third embodiment of an LED retrofit lamp in a view similar to FIG. 4;

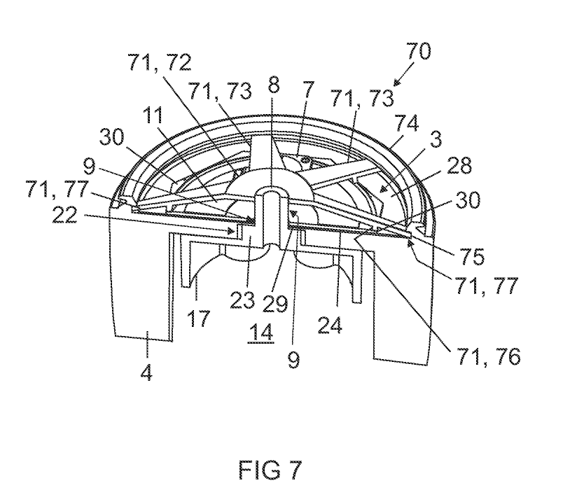

FIG. 7 shows a detail of a fourth embodiment of an LED retrofit lamp in a view similar to FIG. 4;

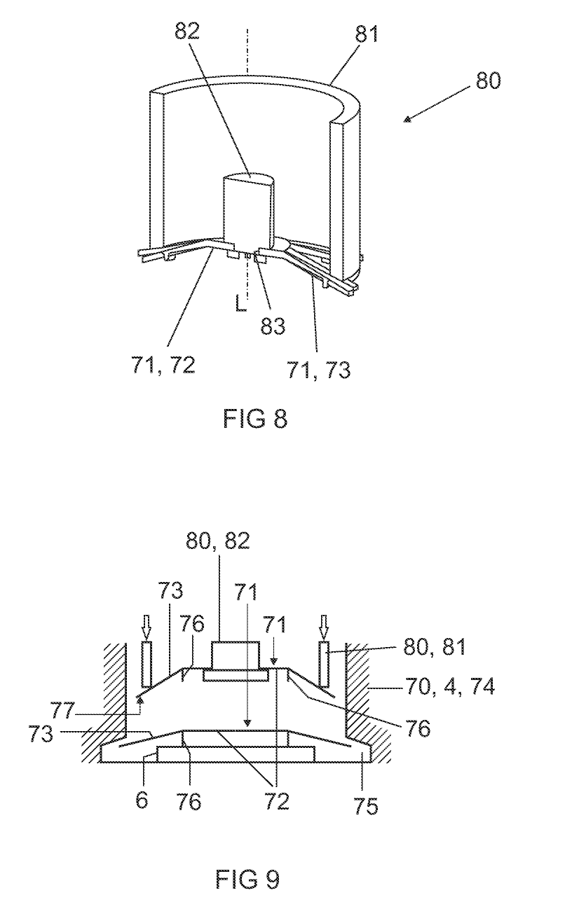

FIG. 8 shows an oblique sectional view of an assembly device for assembling a pressing element on the LED retrofit lamp according to the fourth embodiment;

FIG. 9 shows an assembly process for assembling the pressing element on the LED retrofit lamp according to the fourth embodiment;

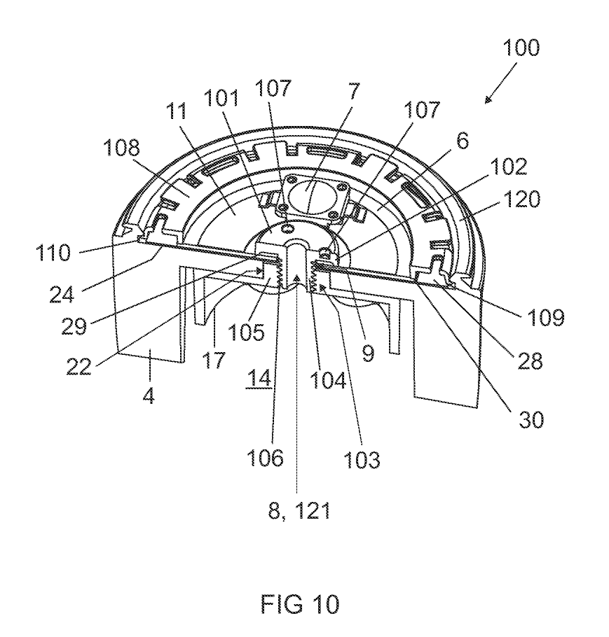

FIG. 10 shows a detail of a fifth embodiment of an LED retrofit lamp in a view similar to FIG. 4;

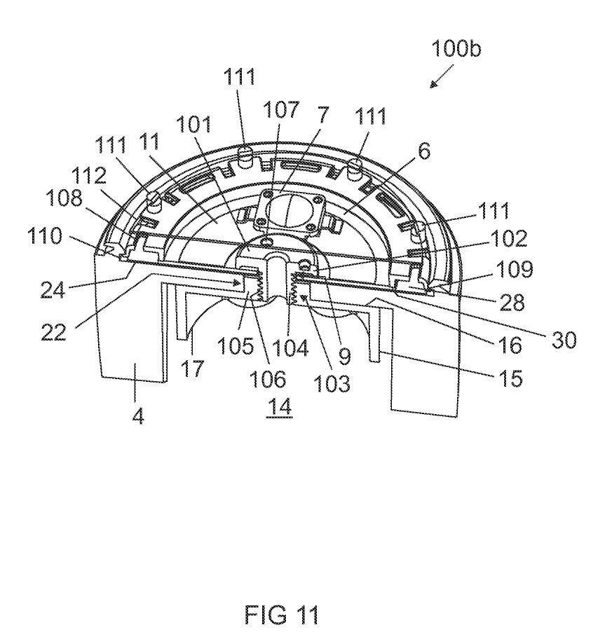

FIG. 11 shows a detail of a sixth embodiment of an LED retrofit lamp in a view similar to FIG. 4;

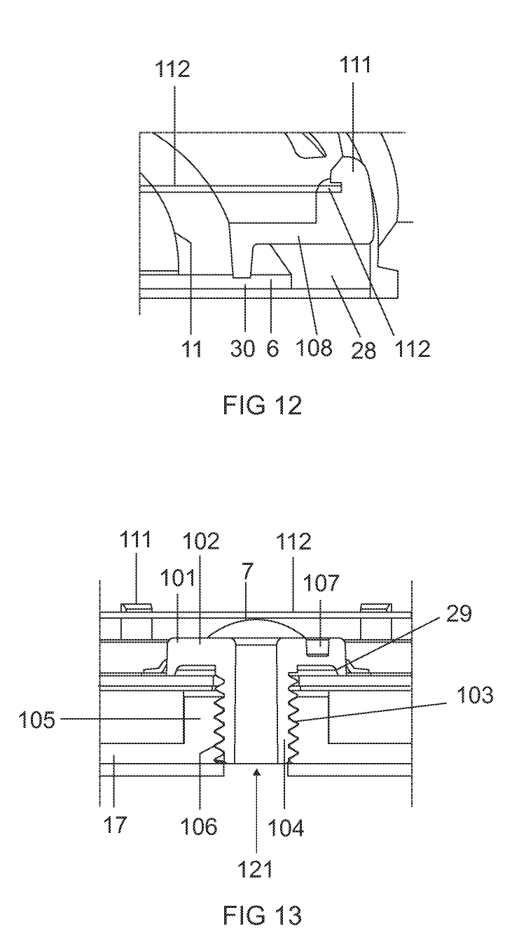

FIG. 12 shows an oblique sectional view of an enlarged detail of the lighting device according to the sixth embodiment in the region of a latching/pressing element;

FIG. 13 shows a lateral sectional view of an enlarged detail of the lighting device according to the sixth embodiment in the region of a screwing/pressing element;

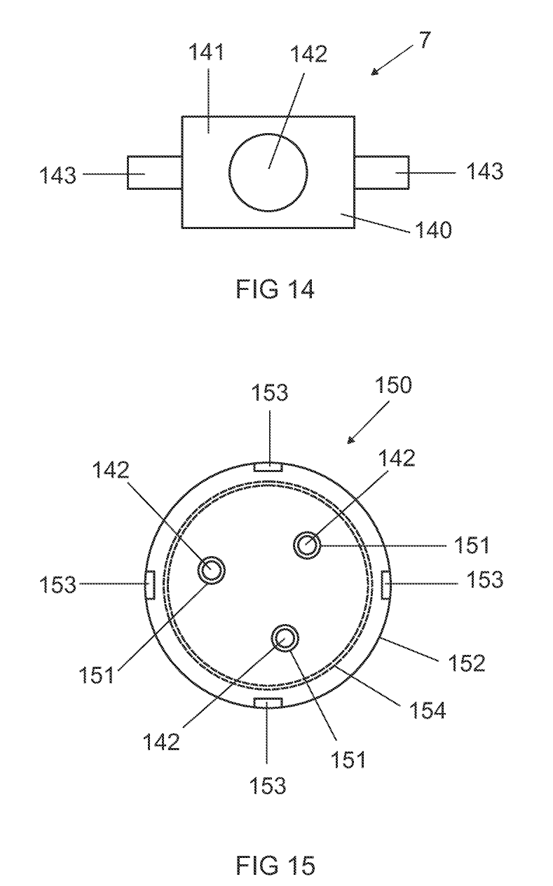

FIG. 14 shows a plan view of an LED of one of the LED retrofit lamps;

FIG. 15 shows a plan view of a covering element for use with the lighting device according to the sixth embodiment;

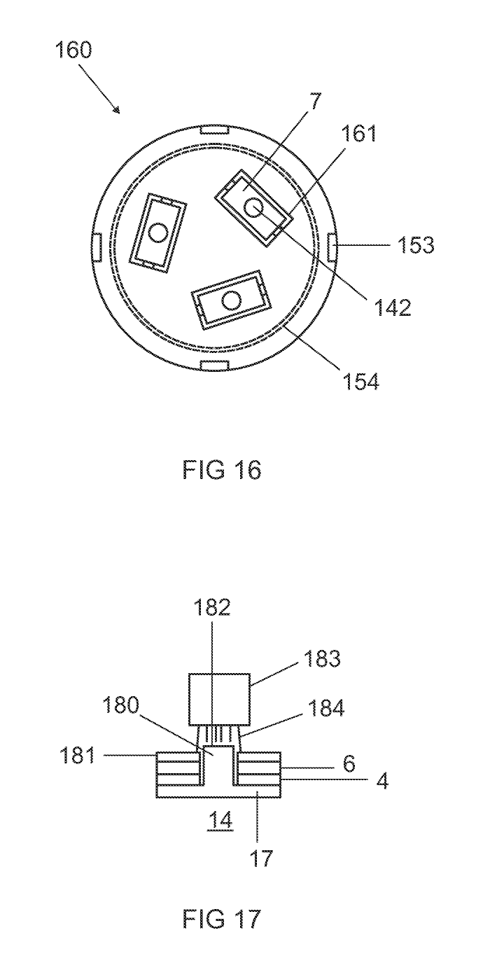

FIG. 16 shows a plan view of a further covering element for use with the lighting device according to the sixth embodiment;

FIG. 17 shows a lateral sectional schematic view of a first process step for forming a hot caulked rivet of a lighting device according to a seventh embodiment;

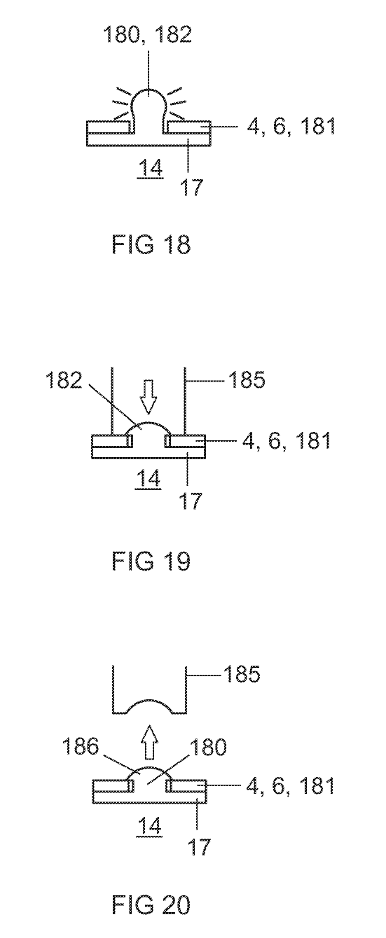

FIG. 18 shows a lateral sectional schematic view of a second process step for forming a hot caulked rivet of the lighting device according to the seventh embodiment;

FIG. 19 shows a lateral sectional schematic view of a third process step for forming a hot caulked rivet of the lighting device according to the seventh embodiment;

FIG. 20 shows a lateral sectional schematic view of a fourth process step for forming a hot caulked rivet of the lighting device according to the seventh embodiment;

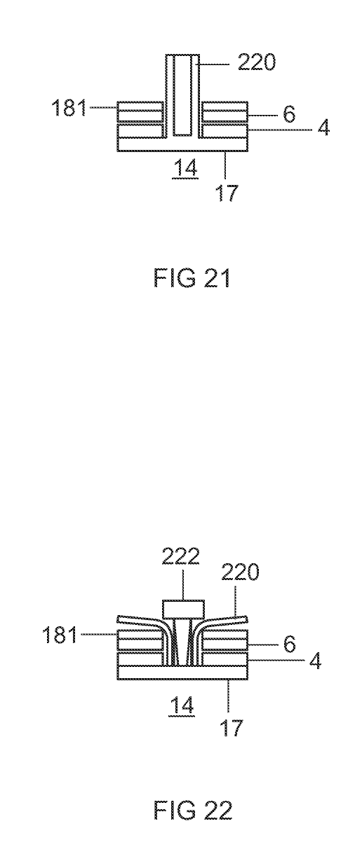

FIG. 21 shows a lateral sectional schematic view of a lighting device according to an eighth embodiment with a slotted bolt in a starting position; and

FIG. 22 shows a lateral sectional schematic view of the lighting device according to the eighth embodiment with the slotted bolt in an end position with a mandrel inserted therein.

FIG. 1 shows a plan view of an LED retrofit lamp 1 according to a first embodiment. The LED retrofit lamp 1 is used in this case to replace a conventional incandescent lamp having an Edison cap and thus has an outer contour which roughly reflects the contour of the conventional incandescent lamp, at least in its basic shape (see FIG. 3 also). The LED retrofit lamp 1 comprises an outer sleeve 2, into which an LED module 3 is inserted. The LED module 3 comprises an aluminium heat sink 4, to the upper face or front face 5 of which shown in this instance an Al₂O₃ carrier 6 with an octagonal outer contour is attached. The carrier 6 is equipped with light sources in the form of LEDs 7. The LEDs 7 illuminate into the upper semi-circle, that is to say in this illustration with a primary beam direction beyond the image plane. The carrier 6 has a central hole, via which the carrier 6 can be plugged tightly over a cable feed element formed in this instance as a cable duct 8. The cable duct 8 acts as an element for passing through electrical lines (not shown) from a driver (not shown) located in the heat sink 4 to the carrier 6. The carrier 6 and the cable duct 8 are thus positioned coaxially in relation to a longitudinal axis L of the lighting device 1 extending perpendicular from the axis of the image, wherein the longitudinal axis L extends centrally through the cable duct 8.

FIG. 2 shows a detailed plan view of the carrier 6 from FIG. 1. A front face 6a of the carrier 6 is equipped with three white LEDs 7 which are arranged approximately angle symmetrically about the longitudinal axis L, wherein the longitudinal axis L extends centrally through the hole 9 in the carrier 6. The LEDs 7 are electrically contactable, for the power supply thereof, to the carrier 6 by means of contact faces 10a. For power supply, electrical lines (not shown) are guided from the driver, through the cable duct to the cable connection surfaces 10b. The electrical conductors used to carry current are formed by a correspondingly structured (shown here in a largely simplified manner) external cooper layer 11. The contact faces 10a as well as the cable connection faces 10b and the cooper layer 11 are potential-carrying surface areas which are electrically insulated, at least by means of the carrier 6, from the heat sink 4 over sufficiently long insulation paths. The copper layer 11 is not completely peripheral, but is interrupted by the LEDs and has a gap 12 extending radially in relation to the longitudinal axis L to avoid a short circuit.

FIG. 3 shows a first embodiment of the LED retrofit lamp 1 in the form of a sectional view along the sectional line A-A from FIG. 1. The LED retrofit lamp 1 does not protrude beyond the outer contour of a conventional incandescent lamp and can be used with its Edison cap 13 as a replacement for a corresponding incandescent lamp. A cylindrical recess in the form of a driver cavity 14 is provided in the heat sink 4 and is coated over its lateral peripheral surface 15 and upper end face 16 with an electrically insulating coating 17 (also referred to hereinafter as a “driver cavity housing” or DCH) made of a plastics material. A lower insertion opening 18 is sealed in an electrically insulating manner from the heat sink 4 by an attachment 19 which also includes the Edison cap 13. A driver circuit board 20 is received in the driver cavity 14 and the coating 17 and comprises all or at least some of the elements required for operation of the LEDs 7. The printed circuit board 20 is thus connected electrically to the Edison cap 13 for power supply and forwards to the LEDs 7 the voltage and/or current required to operate the LEDs 7 via an electrical cable 21. For this purpose the printed circuit board 20 is connected via the electrical cable 21 to suitable cable connection surfaces 10. The driver implemented on the printed circuit board 20 is a non-SELV driver having no transformer in this instance. A separation between the primary side and secondary side takes place primarily between the carrier 6 and the heat sink 4. The non-SELV driver having no transformer may comprise a coil or buck configuration/step-down converter for voltage conversion.

To pass the cable 21 through the upper end face 16, the upper end face 16 has a through-opening 22. To electrically insulate the printed circuit board 20 from the heat sink 4, the coating 17 is formed in such a way that the cable duct 8, which connects the driver cavity 14 or the interior of the coating 17 to the front face 5 of the heat sink 4, is integrated integrally in the coating 17. The front face 5 is covered by an opaque and light-scattering envelope 27 for protection and to homogenise the light irradiated by the lighting device 1. For example, the envelope 27 may be clamped to the heat sink 4.

FIG. 4 shows an oblique view of a detailed portion from the sectional view of the LED retrofit lamp 1 according to the first embodiment. The cable duct 8, which protrudes upwardly beyond the contact surface 24 and which forms part of the coating 17, projects through the central hole 9 in the carrier and comprises a toothing 42, at least on part of its protruding outer face 41. A pressing element 43 is fitted on the cable duct 8 and comprises a toothing 45 (possibly including a catch) on its inner face or inner peripheral surface 44 matching the toothing 42. The pressing element 43 leaves the cable duct 8 open. More specifically, the toothing 42 is provided on a latching annular inner region 46 of the pressing element 43, whilst webs 47 extend downwardly in an inclined manner from the latching annular inner region 46 and rest on the carrier 6.

In an exemplary assembly process, the coating 17 is first inserted into the driver cavity 14 in such a way that the associated cable duct 8 is pushed through the through-opening 22 and thus protrudes out from and beyond the contact surface 24 upwardly and outwardly. The interface layer 28, which has a central hole, is then placed on the contact surface 24 so that it is arranged with only a small clearance or at only a short distance from the cable duct 8. The cable duct 8 thus acts as a centring aid for supporting the interface layer 28. The carrier 6, which is already provided with electrical conductors and is equipped with LEDs 7, is then placed on the transition layer 28. In this case the hole 9 in the carrier 6 is placed on the cable duct 8 so that the cable duct 8 also acts as a centring aid for the carrier 6.

The pressing element 43 is subsequently fitted on the cable duct 8 via its latching annular inner region 46 and is then pressed downwards. Owing to the downwards movement relative to the cable duct 8, the pressing element 43 latches on the cable duct 8 and can no longer be removed therefrom. A fixed support for the counter-force complementary to the pressing force on the carrier 6 is thus provided. As a result of the pressing force, the pressing element is thus resiliently bent by being pressed downwards and is extended and kept tensioned. For the lateral positioning of the webs 47, an annular groove 48 may be provided in the carrier 6 for the insertion of a lateral end of the webs 47, but is not absolutely necessary.

A pressing force of the pressing element 43 on the carrier can be adjusted, at least roughly, by the degree of latching, which also defines the distance between the latching annular inner region 46 and the carrier.

FIG. 5 shows parts of a lighting device 50 in a view similar to FIG. 4, wherein the pressing element 51 is now present as an annular pressing element 51 having the cross-sectional shape of an inverted “U”. The pressing element 51 lies on the carrier 6 via the inner branch 52 and thus acts as a holding-down device. The outer branch of the “U” comprises short, downwardly directed latching hooks 54 spaced at regular intervals over its periphery. The latching hooks are provided to be inserted into a latching seat in the form of a peripheral groove 55, wherein the groove 55 is formed in an edge 56 of the heat sink 4. The edge 56 surrounds the contact surface 24 of the heat sink 4 peripherally at the lateral edge thereof. The pressing element 51 is drawn downwardly by the latching hooks 54 and thus presses the carrier 6 via the inner branch 52 onto the contact surface 24, more specifically over the interface layer 28.

For tolerance compensation of the carrier 6, the upper face of the groove 55, which contacts the latching hook 54, is not horizontal, but is formed at an angle of inclination or at a joining and releasing angle of approximately 10° so that the angle of inclination widens the groove 55 towards the opening thereof. As a result of the angle of inclination, the height of the pressing element 51 can be readjusted, at least within a specific range, according to a fitting height on the carrier 6 and can thus keep a pressing force within a predefined range.

This embodiment affords the advantage of a widely distributed introduction of force which is distributed uniformly in the peripheral direction over the outer edge 30 of the carrier 6, whereby a curling or deforming of the carrier 6 (banana effect), which may occur in particular with a thin carrier 6, is avoided. Such a pressing element 51 can also be implemented in a simple manner.

FIG. 6 shows parts of a lighting device 60 having an annular pressing element 61 similar to the pressing element 51 from FIG. 5, wherein the pressing element 61 now does not have an inverted U-shaped cross-section. Rather, the pressing element 61 is equipped with a cross-sectional annular region 62 which lies against the outer edge 30 of the carrier 6 and is equipped on its outer peripheral surface in the circumferential direction with latching hooks 63 which are received in a corresponding latching seat 64 in the heat sink 4. In contrast to the second embodiment, the latching seat 64 is now provided not in the edge 65 of the heat sink, but as an angled groove in the heat sink 4 extending downwards and perpendicular. The latching hooks 63 are simultaneously broadened and extended.

In contrast to the second embodiment, this third embodiment affords the advantage that the pressing element 61 may also be produced from plastics materials having high temperature stability, which typically tend to fail mechanically, at least in the case of thin structures. Owing to the formation of the actual annular region 62 of the pressing element 61 as the entire body thereof and the greater extension of the latching hooks 63, the volume of the pressing element 61 is increased with an increasingly compact structure of the lighting device 60 to the extent that a failure of the material of the pressing element 61 is avoided.

FIG. 7 shows parts of a lighting device 70 in which the pressing element 71, similarly to the first embodiment, comprises an annular inner region 72 which may be, but does not necessarily have to be equipped with latching means.

The pressing element 71 comprises webs 73 which extend downwardly from the annular inner region 72 in an inclined manner. In contrast to the first embodiment however, the webs 73 are not fitted exclusively on the carrier 6, but are held in a latching seat 75 in the form of an annular groove formed in an edge 74 of the heat sink. In each case, downwardly directed protrusions 76 extend from the webs 73, act as a holding-down device and press onto the carrier 6 from above in order to fix said carrier on the interface layer 28 and contact surface 24. The pressing element 71 may already be tensioned, without a latching of the inner region 72 on the cable duct 8, to such an extent that it presses the carrier 6 onto the contact surface 24. Alternatively, the inner region 72 is equipped, similarly to the inner region 46 of the first embodiment, with a latching mechanism in relation to the cable duct 8 so that the pressing force can be further increased.

FIG. 8 shows an assembly device 80 for use of the pressing element 71 according to the fourth embodiment. The assembly device 80 comprises a tubular outer region 81 and a central retaining element 82. The retaining element 82 is designed to engage in the annular bore 83 in the annular inner region 72 of the pressing element 71 and to thus hold said pressing element in place.

FIG. 9 shows an assembly of the pressing element 71 on the lighting device 70 in two positions, namely an upper starting position and a lower end position.

In the upper starting position the pressing element 71 is held in the assembly device 80 in such a way that the outer region is displaced downwardly in relation to the retaining element, and the retaining element 82 is drawn upwardly into the outer region 81, as indicated by the arrows. The pressing element 71 is thus extended by the retaining element 82 as a tensioning element and by the outer region 81 as a support in the longitudinal direction L by bending the webs 73 downwardly in relation to the annular inner region 72. Consequently, the lateral extension of the pressing element 71 is reduced. The assembly device 80 is dimensioned in such a way that it can be fitted into the edge 74 of the heat sink 4 of the lighting device 70. The deformation of the pressing element 71 is also dimensioned in such a way that it can be inserted into the edge 74.

In a next step the assembly device 80 is lowered downwardly towards the carrier 6 until the peripheral edge regions 77 of the webs are positioned before or beside the latching seat 75. The pressing element 71 will then be relieved of tension by moving the retaining element 82 downwards so that the pressing element 71 is extended laterally and the peripheral edge regions 77 enter the latching seat 75. The retaining element 82 is then released from the annular inner region 72, and the assembly device 80 is removed from the pressing element 71.

The pressing element 71 is also tensioned so that it exerts a sufficient pressing force on the carrier 6. The annular inner region 72 has been placed on the cable duct 8 for centring.

The pressing element 71 may be produced completely from plastics material or may alternatively comprise a metal core encased in plastics material. Owing to the plastics material surface, which is typically electrically insulating, it is ensured that leakage paths and air gaps are not shortened.

FIG. 10 shows a fifth embodiment of a lighting device 100 which comprises two pressing elements 101 and 108, namely a twisting/pressing element 101 and a latching/pressing element in the form of a snap-in ring 108.

The twisting/pressing element 101 is equipped with a laterally extending screw head 102 and a pin-like region 104 provided with an outer thread 103. The twisting/pressing element 101 may be screwed, similarly to a screw, through the hole 9 in the carrier 6 and through a corresponding central hole in the interface layer 28 and into the through-opening 22, more precisely into an insert 105 inserted into the through-opening 22. The insert 105 is part of the coating 17, in which for example, in contrast to the first embodiment, the part protruding upwardly from the contact surface 24 is missing. The insert 105 is equipped with an inner thread 106 into which the pressing element 101 can be screwed via its thread. The pressing element 101 comprises insertion holes 107 in its upper face as points of engagement for the rotating or screwing thereof. The cable duct 8 is formed by means of a slot 121 formed longitudinally in the twisting/pressing element 101. The twisting/pressing element 101 thus comprises a force transmission area on the inner edge 29 of the carrier.

In addition to the twisting/pressing element 101, the lighting device 100 comprises the snap-in ring 108. The snap-in ring 108 is snapped into a peripheral groove 110 formed in the inner face of the peripheral edge 120 of the heat sink 4 via a plurality of latching hooks 109. The snap-in ring 108 thus presses the carrier 6 at the outer edge 30 thereof, as a force transmission area, onto the contact surface 24.

Such a combination of twisting/pressing element 101 and snap-in ring 108 affords the advantage that a defined pressing force can be applied to the carrier 6 by the twisting/pressing element 101, whereas a particularly cost-effective and lightweight transmission of force onto the carrier 6 is provided by the snap-in ring, whereby a relatively uniform pressing force is produced on the whole.

FIG. 11 shows an oblique view of a sixth embodiment of a lighting device 100b, similar to the fifth embodiment. FIG. 12 shows an enlarged view of the lighting device 100b in the region of the snap-in ring 108. FIG. 13 shows a lateral sectional view of the lighting device 100b in the region of the twisting/pressing or screwing/pressing element 101.

Compared to the fifth embodiment of the lighting device 100, the edge-side, annular snap-in ring 108 of the lighting device 100b is now equipped on the upper face with latching hooks 111 for attaching a light-permeable (opaque or transparent) covering disc 112. The covering disc 112 extends just above the LED 7. The covering disc 112 is shown as a simple light-permeable plate in this instance, but may also be formed differently, for example with another basic shape or with an optical function.

Alternatively, the covering disc 112 may also be provided with recesses for the LED 7 and may be lower than shown in FIGS. 11 to 13 so that the LEDs 7 reach through the covering disc 112, as explained in greater detail hereinafter.

FIG. 14 shows a plan view of the LED 7 of one of the LED retrofit lamps. The LED has a housing 140, on the upper face 141 of which a light-emitting surface is located which, for beam guidance, may be covered by a lens 142 and alternatively or additionally by another optical element. The LED 7 is supplied with power via its supply connections 143.

FIG. 15 shows a plan view of a covering element 150 for use, for example, with the lighting device 100b according to the sixth embodiment. The covering element 150 is now formed integrally as a latching/pressing element and, for example, is produced as an injection moulded part. The covering element 150 has three recesses 151 which are introduced into the covering element 150 above the lenses 142 of the LEDs. The lenses 142 reach through the respective recess 151, at least in part, so that the recess does not hinder the beam guidance and the luminous efficacy. At the lateral edge 152, the covering element 150 comprises downwardly oriented latching hooks 153 which, for example, may engage in the latching seat 110. To press the carrier 6, the covering element 150 also comprises a circular protrusion 154 in the direction of the carrier, that is to say generally oriented downwardly, which protrusion is placed pressingly against the carrier 6 and thus acts as a holding-down device. In this case the covering element 150 does not have to be light-permeable, which affords the advantage that it is not possible to see the underlying element. The covering element 150 is preferably formed as a plastics material disc having a flame retardance rating UL94-V1 or better.

FIG. 16 shows a plan view of a further covering element 160 for use for example with the lighting device 100b according to the seventh embodiment. In contrast to the covering element 150, the recesses 161 are now sized and shaped so that the LED 7 is basically completely recessed. For example, the housing 140 may also reach through the recess 161. Such a design may, for example, improve heat dissipation from the LED 7.

FIG. 17 is a schematic view of a further possible embodiment of a pressing element for pressing at least the carrier 6 onto the heat sink 4. For this purpose for example, the coating 17, which is arranged in the driver cavity 14, may comprise a bolt 180 which passes through the heat sink 4, the carrier 6 and possibly further parts of the lighting device, for example a holding-down device 181 or recesses therein, and protrudes upwardly via a free end 182. The bolt 180 or the protruding end 182 thereof is hot caulked, as will be explained hereinafter in greater detail.

Firstly, in a first method step, the free end 182 of the bolt 180 is heated by means of a heat source 183 by infrared radiation 184.

FIG. 18 shows a simplified view of a second method step, in which the heat sink 4, the carrier 6 and any possible further elements such as the holding-down device 181 are shown as a single layer for reasons of simplicity. The bolt 180 has been heated at its free end 182 until it is deformable with only a low level of pressure. In other words, the heat treatment carried out in the first method step has reduced the yield point of the material of the bolt 180.

In a third method step shown in FIG. 19, a cooled die 185 is pressed onto the free end 182, wherein a press mould of the die 185 is designed in such a way that the free end 182 extends laterally so as to be widened over the corresponding recess in at least the uppermost layer.

Owing to the cool die 185, the plastics material hardens again so that when the die 185 is removed in a fourth method step from the bolt 180, as shown in FIG. 20, a hot caulked rivet has been formed which presses together layers 4, 6, 181 provided between its rivet head 186 and its base in the form of the coating 17 provided originally in the driver cavity 14. As a result of the pressing force of the die 185, the pressing force of the carrier 6 onto the contact surface 24 of the heat sink 4 can also be adjusted, at least roughly.

FIG. 21 shows a further pressing element in the form of a slotted, hollow bolt 220 which is in turn guided through corresponding recesses in the heat sink 4, the carrier 6 and a further layer 181, which may possibly be provided, so as to protrude therebeyond.

For assembly of the bolt 220, a pin or mandrel 222 is pressed into the slotted bolt 220, as shown in FIG. 22. The bolt 220 is flared so that it can hold the layers 4, 6, 181 surrounding it permanently under pressure. In order to prevent a release of the mandrel 222 in the bolt 220, both the mandrel 222 and the bolt 220 are equipped with a latching means and a latching counter-means respectively. For example, the mandrel 222 may have a saw-tooth toothing, whereas the inner face of the bolt 220 also has a toothing so that when the mandrel 222 is pressed into the bolt 220, a latching, unreleasable connection is produced. For example, a pressing force may be set so that the mandrel is only pressed into the bolt 220 up to a predefined pressure. Such an embodiment is very easily assembled.

Of course, the present invention is not limited to the embodiments shown.

It may generally also be preferable for the length of the leakage paths to be at least 1 mm, more preferably at least 5 mm.

The material of the heat sink may also comprise, in addition to pure aluminium, an aluminium alloy or another metal or alloy thereof, or an effective heat-conducting plastics material.

Furthermore, the cable duct may also be arranged excentrically (offset laterally to the longitudinal axis). The cable feed element may generally be formed as a separate component or, for example, may be integrated in the coating of the recess and/or in the heat sink, for example integrally.

Generally, the pressing element and the cable duct or the coating may advantageously be produced from a polymer material. A use of electrically noon-conductive materials for the attachment element(s) means that there is no reduction in air gaps or leakage paths.

The interface layer may preferably be produced from a thermal interface material (TIM) or from silicone, etc.

The contact surface may advantageously have a diameter between 20 mm and 30 mm, whereas the carrier may preferably have a diameter between 15 mm and 25 mm.

For example, the carrier may be between 0.16 mm and 1 mm thick, whereas the interface layer may preferably be between 0.15 mm and 0.3 mm thick.

The latching connections and rotary connections (screw connections, bayonet connection, etc.) may generally be secured against release by a cohesive joint, for example by a use of a screw locking adhesive. Alternatively or additionally, the rotary connections may be self-locking, for example by suitable surface structures or geometrical structures.

The outer contour of the carrier is not restricted and may be round or angular for example.

The lighting device may also generally comprise optical elements such as reflectors, lenses (made of glass or plastics material), etc.

In addition, the lamp is also not limited to a specific type of cap. In addition to an Edison cap (for example E14, E27), other caps such as GU10 or standard Japanese or American caps may thus also be used.

### LIST OF REFERENCE NUMERALS

1 LED retrofit lamp
2 sleeve
3 LED module
4 heat sink
5 front face
6a front face
6 carrier
7 LED
8 cable duct
9 hole in the carrier
10 contact face
11 copper layer
12 gap
13 Edison cap
14 driver cavity
15 peripheral surface
16 upper end face
17 coating
18 insertion opening
19 attachment
20 driver printed circuit board
21 cable
22 through-opening
23 radially extended region
24 contact surface
25 protrusion
26 step
27 envelope
28 interface layer
29 inner edge of the carrier
30 outer edge of the carrier
30 outer edge of the carrier
41 outer face
42 toothing
43 pressing element
44 inner face or inner peripheral surface
45 toothing
46 latching annular inner region
47 web
48 annular groove
50 lighting device
51 pressing element
52 inner branch
53 (missing in text, but present in the drawings)
54 latching hook
55 groove
56 edge
60 lighting device
61 pressing element
62 annular region
63 latching hook
64 latching seat
65 edge
70 lighting device
71 pressing element
72 inner region
73 web
74 edge
75 latching seat
76 protrusion
77 edge region
80 assembly device
81 outer region
82 retaining element
83 annular bore
100 lighting device
100b lighting device
101 pressing element
102 screw head
103 outer thread
104 pin-like region
105 insert
106 inner thread
107 insertion hole
108 snap-in ring
109 latching hook
110 peripheral groove
111 latching hook
112 covering disc
120 edge
121 slot
140 housing
141 upper face
142 lens
143 LED
(144 supply connection)
150 covering element
151 recess
152 lateral edge
153 latching hook
154 protrusion
160 covering element
161 covering element
180 bolt
181 holding-down device
182 free end
183 heat source
184 infrared radiation
185 die
186 rivet head
220 bolt
221 bolt
222 mandrel
L longitudinal axis

1. A lighting device comprising:
a body, having an outer contact surface; and
a light source carrier pressed onto the contact surface by at least one pressing element,
wherein the pressing element is latched on the lighting device.

2. The lighting device according to claim 1, wherein the pressing element is latched on the lighting device by at least one latching hook.

3. The lighting device according to claim 2, wherein the pressing element is annular.

4. The lighting device according to claim 2, comprising at least one latching seat for receiving at least one latching hook, wherein at a contact face with the latching hook the latching seat is bevelled in a flared manner toward the opening of the latching seat.

5. The lighting device according to claim 4, wherein an angle of inclination of the contact face is between 5° and 15°.

6. The lighting device according to claim 1, wherein the pressing element is latched on the lighting device by at least one toothed latching ring.

7. The lighting device according to claim 1, wherein the pressing element is latched on the lighting device by at least one toothed latching pin.

8. The lighting device according to claim 1, wherein the pressing element is formed in the manner of a spring washer and is inserted, under tension, into at least one latching seat in the lighting device via at least one peripheral edge region.

9. The lighting device according to claim 1, wherein at least one surface of the pressing element consists of an electrically non-conductive material.

10. The lighting device according to claim 1, further comprising a twisting/pressing element.

11. The lighting device according to claim 1, wherein at least one pressing element is a carrier for a covering.

12. The lighting device according to claim 11, wherein the covering element comprises at least one recess for at least one light source or parts thereof.

13. A method for assembling a lighting device according to claim 8, wherein the method comprises the steps of:
resiliently bending the pressing element so that the lateral extension thereof is reduced;
positioning the peripheral edge region adjacent to the at least one latching seat; and
releasing the pressing element so that the peripheral edge region enters the at least one latching seat.

14. A lighting device, comprising:
a body, having an outer contact surface; and
a light source carrier which is pressed onto the contact surface by at least one pressing element,
wherein the pressing element is a hot caulked plastics material rivet.

15. A lighting device, comprising:
a body, having an outer contact surface; and
a light source carrier, which is pressed onto the contact surface by at least one pressing element,
wherein the pressing element is a latchingly expandable expansion sleeve.

16. The lighting device according to claim 1, wherein said body is a heat sink, and said light source carrier is an LED carrier.

17. The lighting device according to claim 9, wherein said electrically non-conductive material is a plastics material.

18. The lighting device according to claim 14, wherein said body is a heat sink, and said light source carrier is an LED carrier.

19. The lighting device according to claim 15, wherein said body is a heat sink, and said light source carrier is an LED carrier.
